(19) United States
(12) Patent Application Publication
(10) Pub. No.: US 2023/0191973 A1
(43) Pub. Date: Jun. 22, 2023

(54) VEHICLE SEAT ASSEMBLY WITH MASSAGE

(71) Applicant: Lear Corporation, Southfield, MI (US)

(72) Inventors: Francesco MIGNECO, Saline, MI (US); Sajad ARABNEJAD, Ann Arbor, MI (US); David GALLAGHER, Sterling Heights, MI (US); Nathan MADLAMBAYAN, Bloomfield Hills, MI (US); Michael-Armen KADIAN, Bloomfield Township, MI (US)

(21) Appl. No.: 17/557,338

(22) Filed: Dec. 21, 2021

(51) Int. Cl. B60N 2/90; B60N 2/80; A61H 9/00

(52) U.S. Cl. CPC B60N 2/976; B60N 2/80; A61H 9/0078; B60N 2002/899; A61H 2201/0149; A61H 2201/1604; A61H 2205/04; A61H 2201/5002; A61H 2203/0431

(57) ABSTRACT

A vehicle seat assembly is provided with a seat back and a head restraint assembly supported by the seat back. The head restraint assembly has a substrate with a main body extending from a transverse mounting surface to an upper edge of the head restraint assembly, and a projection extending downwardly from the mounting surface of the main body to a lower end of the head restraint assembly. The main body and the projection cooperating to define a continuous support surface for an occupant. A first massage element and a second massage element are supported by the projection. The first and second massage elements and the lower end of the head restraint assembly are positioned between the mounting surface and the lower end of the head restraint assembly. A head restraint assembly and a method of controlling a vehicle seat assembly are also provided.

### TECHNICAL FIELD

Various embodiments relate to a head restraint for a vehicle seat assembly.

### BACKGROUND

Vehicle seat assemblies may be provided with head restraints to support the head of an occupant. Examples of vehicle seat assemblies with head restraints may be found in U.S. Pat. Nos. 7,364,239, 8,840,185, U.S. Pat. Pub. No. US 2020/0215949, and Chinese Pat. Pub. No. CN 203580711 U.

### SUMMARY

In an embodiment, a vehicle seat assembly has a seat back extending upwardly from a seat cushion to an upper end, with the seat back having a front surface to support an occupant. A head restraint assembly is supported by the seat back. The head restraint assembly has a substrate defining a main body to support a head of the occupant, with the main body extending from a transverse mounting surface to an upper edge of the head restraint assembly. The mounting surface is shaped to cooperate with the upper end of the seat back and support at least one support member coupling the head restraint assembly to the seat back. The substrate also defines a projection extending downwardly from the mounting surface of the main body to a lower end of the head restraint assembly, with the main body and the projection cooperating to define a continuous support surface for an occupant. A first massage element and a second massage element are supported by the projection, and the first and second massage elements and the lower end of the head restraint assembly are positioned between the mounting surface and the lower end.

In a further embodiment, the first massage element is provided by a first bladder, and the second massage element is provided by a second bladder.

In an even further embodiment, the vehicle seat assembly has at least one valve in fluid communication with the first bladder and the second bladder. A controller is in communication with the at least one valve to control inflation of the first bladder and inflation of the second bladder.

In another even further embodiment, the controller controls the at least valve to inflate the first bladder and inflate the second bladder in response to receiving a signal indicative of the seat back being in a reclined position such that the first and second bladders cooperate to define a cradle.

In an even further embodiment, the controller controls the at least valve to provide a massage effect via the first and second bladders.

In an even yet further embodiment, the controller controls an inflation duration and/or an inflation level of each of the first and second bladders to provide the massage effect as a selected one of a plurality of massage effects.

In another further embodiment, the projection is positioned to contact at least one vertebra of the occupant in a range of C2 to T5 vertebrae.

In a further embodiment, the head restraint assembly has a third massage element and a fourth massage element supported by the substrate. The first and second massage elements are positioned between the lower end of the substrate and the third and fourth massage elements.

In an even further embodiment, the first and second massage elements are laterally opposite to one another. The third and fourth massage elements are laterally opposite to one another.

In an even yet further embodiment, the first and second massage elements are spaced apart from one another by a first distance, and the third and fourth massage elements are spaced apart by a second distance.

In a yet even yet further embodiment, the second distance is less than the first distance.

In another further embodiment, the first massage element is provided by a first massage node, and the second massage element is provided by a second massage node.

In an even further embodiment, at least one actuator is connected to the first massage node and the second massage node. A controller is in communication with the at least one actuator to control the first massage node and the second massage node to provide a massage effect for the occupant.

In a further embodiment, the head restraint assembly has a carrier plate connecting at least one of the first and second massage elements to the projection, with the carrier plate movable relative to the projection to adjust a location of the at least one of the first and second massage elements relative to the projection.

In another further embodiment, a midline of the head restraint assembly extends between the first massage element and the second massage element.

In a further embodiment, the head restraint assembly has a trim cover extending over the main body, the projection, and the first and second massage elements of the head restraint assembly, the trim cover having a tie down connecting the trim cover to the projection between the first and second massage elements.

In another embodiment, a vehicle seat assembly is provided with a substrate defining a continuous support surface for an occupant, with the continuous support surface extending downwardly to overlap a head and at least one vertebra of the occupant in a range of C2 to T5 vertebrae. A pair of massage elements is supported by the continuous support surface such that the pair of massage elements is positioned to contact the occupant in the range.

In a further embodiment, a second pair of massage elements is supported by the substrate, with the second pair of massage elements positioned between an upper edge of the head restraint and the first pair of massage elements.

In another further embodiment, a second pair of massage elements is supported by the substrate, with the first pair of massage elements transversely positioned between the second pair of massage elements.

In an embodiment, a method of controlling a vehicle seat assembly is provided. The first and second massage elements of a downwardly extending projection of a head restraint assembly, positioned between a transverse mounting surface and a lower edge of the head restraint assembly are selectively actuated to provide a massage effect to at least one vertebra of an occupant in a range of C2 to T5 vertebrae. The first and second massage elements are concurrently actuated in response to a seat back being in a reclined position such that the first and second massage elements cooperate to define a cradle.

### BRIEF DESCRIPTION OF THE DRAWINGS

FIG. 1 illustrates a schematic of a vehicle seat assembly according to an embodiment;

FIG. 2 illustrates a partial front view of a head restraint assembly according to an embodiment and for use with the vehicle seat assembly of FIG. 1;

FIG. 3 illustrates a partial side view of the head restraint assembly of FIG. 2;

FIG. 4 illustrates a partial perspective view of a head restraint assembly according to another embodiment and for use with the vehicle seat assembly of FIG. 1;

FIG. 5 illustrates a partial perspective view of a head restraint assembly according to yet another embodiment and for use with the vehicle seat assembly of FIG. 1; and

FIG. 6 illustrates a partial schematic view of a head restraint assembly according to another embodiment and for use with the vehicle seat assembly of FIG. 1.

### DETAILED DESCRIPTION

As required, detailed embodiments of the present disclosure are provided herein; however, it is to be understood that the disclosed embodiments are merely examples and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

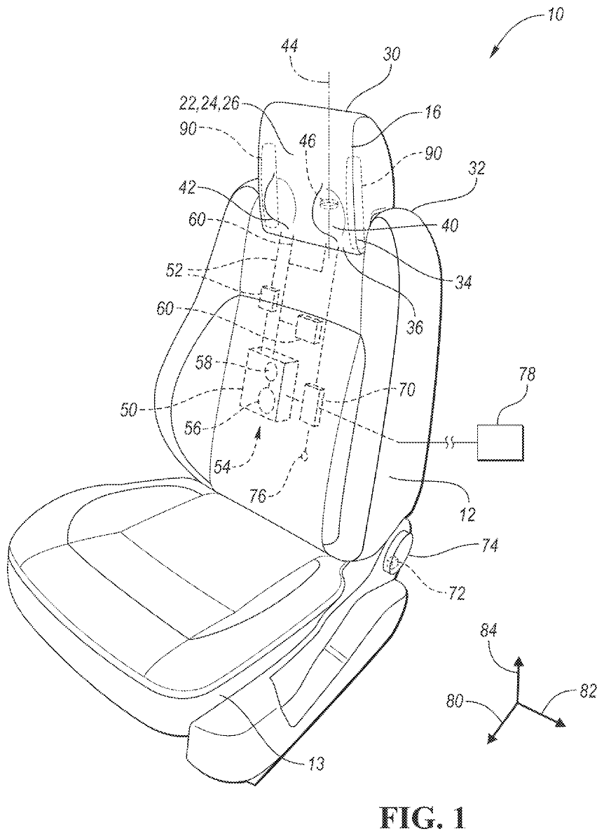

FIG. 1 illustrates a schematic of a vehicle seat assembly 10. The vehicle seat assembly 10 may be used as a front seat for a driver or passenger, or may be used in a second or other row of seats according to various embodiments.

The seat assembly 10 has a support structure, such as a seat back 12 and a seat cushion 13. The seat back 12 and seat cushion 13 define a seating surface or front surface for an occupant of the seat. The upper end of the seat back 12 defines a pair of guides, although any number of guides are contemplated, such as a single guide or more than two guides.

The seat back 12 supports a head restraint 16 which has a pair of support members 18, such as support rods or posts, as shown in FIG. 3 for example. Each support member 18 slides into a respective guide. In one example, the support members 18 allow the head restraint 16 to translate with respect to the seat back 12. The head restraint 16 has a substrate 22 which is connected to the support members 18.

In other examples, the head restraint 16 and substrate 22 may be integrally formed with or connected to the seat back 12, such that there are no support members 18 or associated guides, and the head restraint position may not be adjusted relative to the seat back.

The substrate 22, as further described below, is covered with a foam cushion or other padding material, which in turn may be covered with a trim cover 24 formed from a fabric, leather, or other similar material to act as cushioning and trim for the head restraint 16.

The substrate 22 forms a main body 26 to support a head of the occupant. The main body extends from a transverse mounting surface 28 to an upper edge 30 of the head restraint assembly. The mounting surface 28 may be shaped to cooperate with the upper end 32 of the seat back and support at least one support member 18 coupling the head restraint assembly to the seat back 12.

The substrate 22 also defines a projection 34 extending downwardly from the mounting surface 28 of the main body 26 to a lower end 36 of the head restraint assembly. The main body 26 and the projection 34 cooperate to define a continuous support surface 38 for a head and a neck and shoulder region of an occupant. The projection 34 is sized to extend downwardly to overlap the front seating surface of the seat back 12 when the head restraint 16 is installed on the seat back 12. Additionally, the projection 34 is sized and shaped to overlap, contact or engage the neck and shoulder region of the occupant, or overlap or contact at least one vertebra within a C2 to C7 range of vertebrae of the occupant, or at least one vertebra in the cervical vertebrae. Furthermore, the projection 34 may be sized to overlap, contact or engage with at least one of the thoracic vertebrae, and may extend as far downwardly as the T4 or T5 vertebra of an occupant.

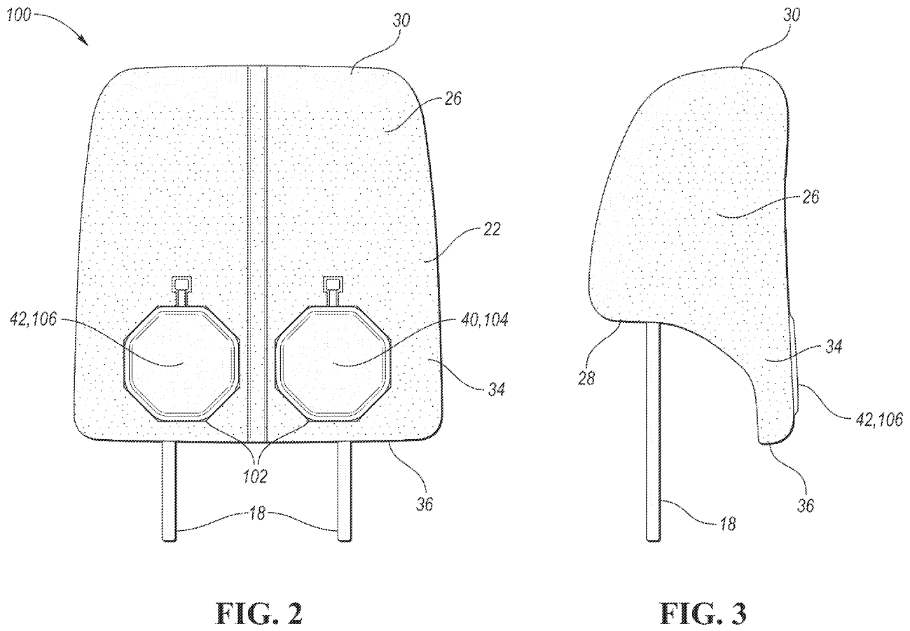

The substrate 22 supports one or more massage elements, as described in further detail below and with reference to FIGS. 2-6. As shown in the example in FIG. 1, the head restraint 16 has a first massage element 40 and a second massage element 42 each supported by the projection 34. The first and second massage elements 40, 42 are positioned between the mounting surface 28 and the lower end 36 such that the massage elements 40, 42 provide a massage to the occupant across the cervical and/or thoracic range as described above to massage muscle and tissue laterally adjacent to these vertebrae in the neck and shoulder region of the occupant. In other examples, other numbers of massage elements may be provided and supported by the substrate 22, including four, six, or more than six massage elements. Some or all of the massage elements may be supported by the projection 34.

The first and second massage elements 40, 42 are positioned to be laterally opposite to one another, with a midline 44 of the head restraint 16 extending between the first and second massage elements 40, 42. The trim cover 24 extends over the main body and the projection of the substrate 22, as well as the first and second massage elements 40, 42 of the head restraint assembly. The trim cover 24 may be provided with a tie down 46 connecting the trim cover 24 to the substrate 22 and projection 34 between the first and second massage elements 40, 42. The tie down 46 may prevent tenting of the trim cover between the massage elements, and maintain the trim cover in the desired position. In other examples, the trim cover 24 is provided without a tie doe 46 between the massage elements.

The vehicle seat assembly 10 may additionally include and support a heating and/or cooling system 50 for the occupant, and the heating and/or cooling system 50 may extend into the head restraint 16 and projection 34. The heating and/or cooling system 50 may include heating elements 52 supported within the vehicle seat assembly. The heating elements 52 may be provided by resistive heaters, infrared cloth, Peltier cells, or other heating elements as is known in the art. The heating and/or cooling system 50 may additionally or alternatively include a airflow ventilation system 54 to provide air through channels and perforations 60 in the vehicle seat assembly to heat or cool the occupant. The system 54 includes an air pump 56, as well as valves 58 to control the air flow through the vehicle seat assembly. For a system 50 that provides heating, a heating element is additionally provided to heat the air flow to the occupant. The system 50 therefore may provide conditioned or unconditioned air flow for thermal comfort purposes for the occupant, and may provide unconditioned air as ventilation to or from the occupant, and conditioned air as actively cooled or warmed air directed toward the occupant from the seat. The heating and/or cooling system 50 may additionally be supported by the head restraint 16 and provide heating and/or cooling effects to the occupant via the head restraint.

Additionally, and in various examples, the vehicle seat assembly, including the head restraint, may include pulsated electromagnetic field (PEMF) coils to provide pulsed energy therapy to the occupant. The PEMF coils may be provided adjacent, posterior, or anterior to the massage elements 40, 42, and supported by the projection 34 according to one example.

A controller 70 is in communication with the massage elements 40, 42 to control the operation of the massage elements. The controller 70 may be provided as one or more controllers or control modules for the various vehicle components and systems. The controller 70 and control system for the vehicle may include any number of controllers, and may be integrated into a single controller, or have various modules. Some or all of the controllers may be connected by a controller area network (CAN) or other system. It is recognized that any controller, circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electrical devices as disclosed herein may be configured to execute a computer-program that is embodied in a non-transitory computer readable medium that is programmed to perform any number of the functions as disclosed herein.

The vehicle seat assembly 10 has a longitudinal axis 80, a lateral or transverse axis 82, and a vertical axis 84. The seat back 12 may be rotated relative to the seat cushion 13 from a first, generally upright position as shown, to a reclined position. When the seat back 12 is rotated or reclined, the head restraint 16 may move with the seat back relative to the seat cushion 13. A sensor 72 may be provided to provide an indication of the recline angle or position of the seat back relative to the seat cushion, and may be provided within the recline mechanism 74.

The controller 70 may additionally receive an input from a vehicle system with a signal indicative of the vehicle operating or being in motion. Alternatively, the vehicle seat assembly 10 may include a sensor 76, such as an accelerometer, to determine whether the vehicle is operating and in motion.

The controller 70 may control the operation of the massage elements 40, 42 to provide a selected massage effect. The controller 70 may control the timing, duration, speed, pressure, and/or movement of each massage element 40, 42 to provide the selected massage effect. The controller 70 may control the massage elements 40, 42 to operate simultaneously or in unison, or alternating. For head restraints 16 with more than two massage elements 40, 42, or for a vehicle seat assembly and head restraint with more that two massage elements, the controller 70 may operate the massage elements sequentially to provide a wave action effect. The controller 70 may also operate the massage elements 40, 42 independently to provide any desired massage pattern or effect. The user may select the type of massage from a predetermined menu or list of options for massage effects via the user interface 78.

In one example, the controller 70 receives a signal from a user interface 78 with a request to operate the massage elements 40, 42, and controls the massage elements 40, 42 based on the user input. The user interface 78 may be supported on the vehicle seat assembly 10 itself, may be supported elsewhere in the vehicle, or may be provided on a personal mobile device of the user in wireless communication with the controller 70. The user may request operation of the massage elements 40, 42 in the head restraint alone, or may request a massage function or therapeutic program from the vehicle seat assembly 10, with the therapeutic program including operation of the head restraint massage elements 40, 42, other vehicle seat massage elements, the heating and cooling system 50 in the vehicle seat assembly, and/or PEMF coils.

In other examples, the controller 70 may control the massage elements 40, 42 as a part of a biotherapy program integrated with the vehicle seat assembly 10, e.g. as a part of a meditation breathing therapy. For example, the controller 70 may sense the breathing pattern of a seat occupant, and sync the massage pattern, or massage element 40, 42 bladder inflation and deflation, to the breathing pattern. In another example, the user may select the biotherapy program, and the controller 70 may provide guided instructions for breathing inhalations to the occupant via the user interface, and sync the massage pattern, or bladder inflation and deflation, to the instructions.

In a further example, the controller 70 operates the massage elements 40, 42 when the vehicle is parked, or is not operating or driving based on a signal from the vehicle system or sensor 76.

The controller 70 may operate the massage elements 40, 42 to provide a massage effect when the seat back 12 is in a reclined position, e.g. when the seat back 12 is reclined more than 30 degrees reclined from the vertical axis and relative to the seat cushion 13, or more than 45 degrees reclined from the vertical axis and relative to the seat cushion. In some examples, the massage effect is only provided when the seat back 12 is in a reclined position and when the vehicle is not operating, e.g. for a driver seat. In further examples, the massage effect is provided by the massage elements through a range of seat back recline angles, including zero degrees recline from the vertical axis (or ninety degrees relative to the seat cushion) through 90 degrees reclined from the vertical axis (or 180 degrees relative to the seat cushion). In other examples, the massage effect may be provided regardless of the seat recline angle or vehicle operating state, e.g. for a passenger seat in a vehicle, or for any seat in an autonomous vehicle.

In some examples, the head restraint 16 may further include a pair of side pillows 90 provided by additional air bladders that are in fluid communication with the system 50 for selective inflation, or via mechanically moved members or wings on the head restraint 16. The pair of side pillows 90 may be inflated to provide a cradle shape for the head and/or neck of the occupant. The controller 70 may control the pair of side pillows 90 to inflate while operating the massage elements 40, 42. In other examples, the pair of side pillows 90 may additionally be inflated or articulated when the massage elements 40, 42 are not in operation. Alternatively, the head restraint 16 may be provided without side pillows 90, and the controller may operate or inflate each of the pair of massage elements 40, 42 to a static inflation state to provide a cradle; however, in this example, the cradling massage elements 40, 42 are then unavailable to provide a massage effect.

FIGS. 2 and 3 illustrate a head restraint assembly 100 according to an embodiment and for use with the vehicle seat assembly of FIG. 1 as head restraint 16. The trim cover is removed from the head restraint of FIGS. 2-3, and is therefore not shown. Elements that are the same as or similar to those described above with respect to FIG. 1 are given the same reference number for simplicity.

The head restraint substrate 22 is shown in FIGS. 2-3, and may be formed from a foam or other cushion element. In one example, the substrate 22 is integrally formed from a single piece of foam. Alternatively, the substrate 22 may be formed from multiple pieces of foam that are bonded or otherwise connected to one another to form an integral substrate element, or may be integrally formed with the seat back 12 as described above.

The substrate 22 defines the main body 26 and projection 34 as described above. The projection 34 defines a pocket 102 or recess sized to receive an associated massage element 40, 42. As shown in FIGS. 2-3, the head restraint has first and second massage elements 40, 42 received within two pockets 102 according to one non-limiting example.

The first and second massage elements 40, 42 are provided by a first bladder 104 and a second bladder 106, respectively. The bladders 104, 106 are shown as being deflated in FIGS. 2-3. The first and second bladders 104, 106 are in fluid communication with the system 50 of the vehicle seat assembly, and air flow to the first and second bladders is controlled by at least one valve, such as valve 58 to selectively inflate and deflate the bladders to provide the selected massage effect. In the example shown in FIGS. 2-3, each bladder may be fluidly connected to separate valves to control air flow to each bladder independent of the other. A controller 70 is in communication with the at least one valve 58 to control inflation of the first bladder and inflation of the second bladder.

The controller 70 may control the at least valve 58 to inflate the first bladder 104 and inflate the second bladder 106 in response to receiving a signal indicative of the seat back 12 being in a reclined position such that the first and second bladders 104, 106 cooperate to define a cradle. The controller 70 may also control the at least valve 58 to provide a massage effect via the first and second bladders 104, 106 by selectively inflating and deflating the first and second bladders. According to various examples, the controller 70 may control an inflation duration and/or an inflation level of each of the first and second bladders 104, 106 to provide the massage effect as a selected one of a plurality of massage effects, as well as control the pressure, timing or speed of the inflation and deflation, or cycles of inflation and deflation, and in a uniform or dissimilar period of inflation and deflation, of the bladders 104, 106.

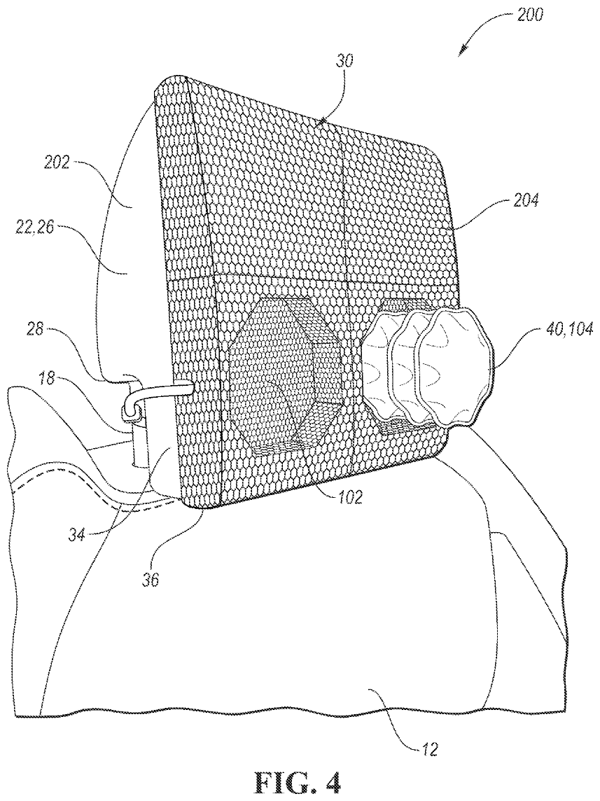

FIG. 4 illustrates a partial perspective view of a head restraint assembly 200 according to another embodiment and for use with the vehicle seat assembly of FIG. 1. The trim cover is removed from the head restraint of FIG. 4, or the head restraint is provided in the vehicle seat assembly without a trim cover, and it is therefore not shown. Elements that are the same as or similar to those described above with respect to FIGS. 1-3 are given the same reference number for simplicity.

In FIG. 4, the substrate 22 of the head restraint assembly 200 is formed via a three-dimensional printing technique. In various examples, the substrate 22 is therefore formed or printed as an integral component with both the main body 26 and the projection 34. The substrate 22 may include a rigid support element 202 as well as a foam pad 204 printed with voids and from a metamaterial to provide the appropriate mechanical properties. The substrate is 22 additionally printed with a recess or pocket 102 for each massage element 40, 42. The massage elements 40, 42 may be provided by a first and second bladders 104, 106 as described above. FIG. 4 illustrates only one bladder 104 in order to illustrate an empty pocket 102. The bladder 104 is additionally illustrated in an inflated state.

When the head restraint 200 of FIG. 4 is provided without a trim cover or with only a partial trim cover, and as shown, the massage bladders 104, 106 are exposed and form a part of the styling or outward appearance of the vehicle seat assembly.

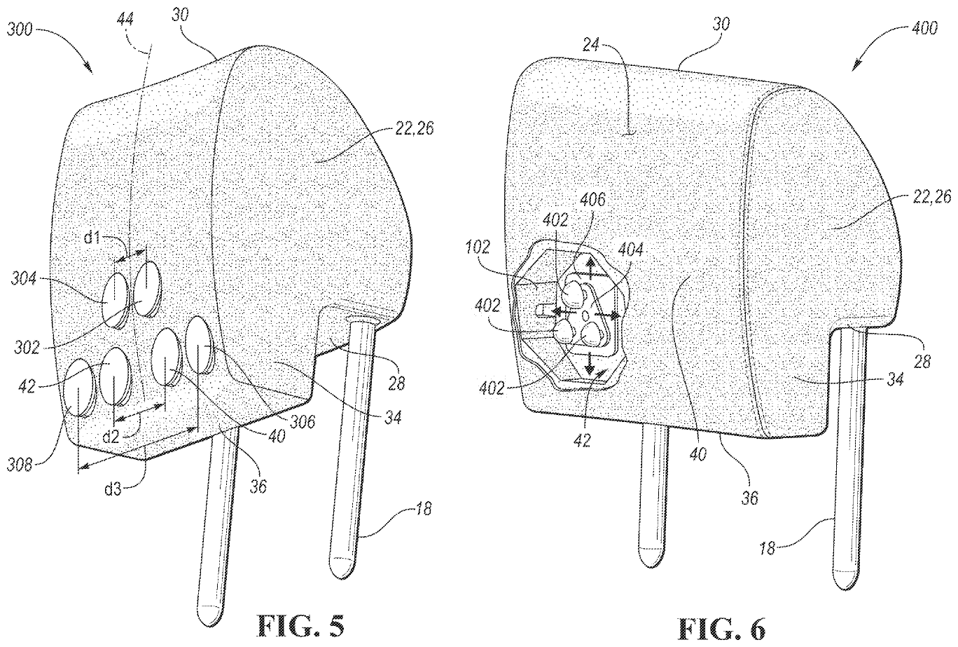

FIG. 5 illustrates a partial perspective view of a head restraint assembly 300 according to yet another embodiment and for use with the vehicle seat assembly of FIG. 1. The trim cover is removed from the head restraint of FIG. 5, or the head restraint is provided in the vehicle seat assembly without a trim cover, and it is therefore not shown. Elements that are the same as or similar to those described above with respect to FIGS. 1-4 are given the same reference number for simplicity.

The substrate 22 may be formed from a foam element over a frame, or from a three-dimensional material as described above with respect to FIGS. 2-4. The substrate 22 supports up to six massage elements as shown. In other examples, the head restraint and substrate may support more than six massage elements, or only two or four massage elements. The massage elements may be arranged in horizontal pairs, as shown, and furthermore, may be arranged symmetrically on the head restraint 300 and relative to the midline 44.

The first and second massage elements 40, 42 are supported by the projection 34 of the substrate 22. The head restraint assembly 300 also has third and fourth massage elements 302, 304 and fifth and sixth massage elements 306, 308 that are supported by the substrate 22, and that may be supported by the main body 26, or within the projection 34.

The first and second massage elements 40, 42 may be laterally opposite to one another, and separate by a midline 44 of the head restraint. Likewise, the third and fourth massage elements 302, 304 may be laterally opposite to one another, and separate by a midline 44 of the head restraint. The fifth and sixth massage elements 306, 308 may be laterally opposite to one another, and separate by a midline 44 of the head restraint. Additionally massage elements may also be provided as pairs of massage elements, with each pair being laterally arranged, and separated by the midline.

In one example, the first and second massage elements 40, 42 are positioned between the lower end 36 of the head restraint assembly and the third and fourth massage elements 302, 304. In this example, the first and second massage elements 40, 42 are spaced apart vertically from the third and fourth massage elements 302, 304. The first and second massage elements 40, 42 are spaced apart from one another by a first transverse distance d1, and the third and fourth massage 302, 304 elements are spaced apart from one another by a second transverse distance d2. The second distance d2 is less than the first distance d1, such that the spacing between massage elements in a pair increases towards the lower end 36 of the head restraint.

In another example, the first and second massage elements 40, 42 are positioned transversely between the fifth and sixth massage elements 306, 308. In this example, the first, second, fifth, and sixth massage elements 40, 42, 306, 308 are all laterally arranged or spaced relative to one another along a common transverse axis. The first and second massage elements 40, 42 are spaced apart from one another by a first transverse distance d1, and the fifth and sixth massage elements 306, 308 are spaced apart from one another by a third transverse distance d3. The third transverse distance d3 is greater than the first transverse distance d1.

FIG. 6 illustrates a partial schematic view of a head restraint assembly 400 according to another embodiment and for use with the vehicle seat assembly of FIG. 1. The trim cover 24 is shown as partially removed from the head restraint of FIG. 6. Elements that are the same as or similar to those described above with respect to FIGS. 1-4 are given the same reference number for simplicity. The substrate 22 may be formed from a foam element over a frame, or from a three-dimensional material as described above.

The substrate 22 defines first and second recesses or pockets 102, with each recess or pocket sized to receive a massage element 40, 42. In the example shown in FIG. 6, only one massage element 42 is illustrated, and is provided by massage nodes 402 that are mechanically moved via an actuator 404 to provide the massage effect. The massage nodes 402 may be formed from a plastic material, a rubber material, or the like. The actuator 404 may be provided by an electric motor driving the node in an elliptical motion, a circular motion, and/or a linear motion via a transmission. Alternatively, the actuator 404 may be provided by a linear actuator, servo motor, and/or pneumatic systems. A single actuator may drive both massage elements, or each massage element may be independently driven by an associated actuator. The controller 70 is in communication with the actuator to control the movement of the massage elements 40, 42 and provide the selected massage effect.

The nodes 402 may be supported within the recesses 102 of the projection on carrier plates 406. Each carrier plate 406 is moveable relative to the substrate 22 to adjust the location or position of the massage element relative to the projection and head restraint. The carrier plates 406 may be moved via electric motors, servo motors and pneumatic systems, and additionally may be moved via additional bladders positioned behind the carrier plate or directly behind the associated massage element, e.g. in the fore aft position. The controller 70 is in communication with a motor (not shown) to control the position of the carrier plates 406 based on a user input, or based on a sensor input to the controller 70 as described above. Each massage element 40, 42 or node is movable relative to the carrier plate 406 to provide the massage effect. In other examples and according to further embodiments, carrier plates 406 may be used with the head restraints and massage elements of FIGS. 1-5, with one or more bladders mounted on each carrier plate.

The carrier plate 406 may be moved along the lateral and/or vertical axis to adjust the position of the massage elements 40, 42 relative to the occupant, e.g. up/down and left/right movement. The carrier plate 406 may additionally be moved along the longitudinal axis, e.g. fore/aft movement. The carrier plate 406 may be translated along the axes and relative to the substrate 22. Alternatively, the carrier plate 406 may be rotated relative to the substrate 22 to adjust the position of the massage elements 40, 42, e.g. via a tilt motion.

The first and second massage elements 40, 42 may be supported on a single carrier plate such that they move together. Alternatively, the first and second massage elements 40, 42 are supported by first and second carrier plates, respectively and as shown, such that the first and second massage element 40, 42 positions may be individually and separately controlled.

The carrier plates 406 may be moved based on a user input to the user interface 78 and controller 70. Alternatively, the carrier plates 406 may be moved based on a signal from a pressure sensor in the substrate 22 to locate the massage elements 40, 42 relative to the occupant, e.g. using pressure feedback to the controller 70.

In various examples, a method of controlling a vehicle seat assembly 10 and associated head restraint 16 is provided. The first massage element 40 and the second massage element 42 are supported in a downwardly extending projection 34 of a substrate 22 of a head restraint assembly such that the first and second massage elements 40, 42 are positioned between a transverse mounting surface 28 and a lower end 36 of the head restraint assembly. The first and second massage elements 40, 42 are selectively actuated by a controller 70 to provide a massage effect to at least one vertebra of an occupant in a range of C2 to C7 vertebrae, or to at least one vertebra in a C2 to T5 vertebrae range. The first and second massage elements 40, 42 are concurrently actuated by the controller 70 in response to a seat back 12 being in a reclined position such that the first and second massage elements 40, 42 cooperate to define a cradle.

While various embodiments are described above, it is not intended that these embodiments describe all possible forms of the disclosure and/or invention. Rather, the words used in the specification are words of description rather than limitation, and it is understood that various changes may be made without departing from the spirit and scope of the disclosure. Additionally, the features of various implementing embodiments may be combined to form further embodiments of the invention.

What is claimed is:

1. A vehicle seat assembly comprising:
a seat back extending upwardly from a seat cushion to an upper end, the seat back having a front surface to support an occupant; and
a head restraint assembly supported by the seat back, the head restraint assembly comprising:
a substrate to support a head of the occupant, the substrate defining a main body and a projection, the main body extending from a transverse mounting surface to an upper edge of the head restraint assembly, the mounting surface shaped to cooperate with the upper end of the seat back and support at least one support member coupling the head restraint assembly to the seat back, the projection extending downwardly from the mounting surface of the main body to a lower end of the head restraint assembly, the main body and the projection cooperating to define a continuous support surface for an occupant, and
a first massage element and a second massage element supported by the projection, wherein the first and second massage elements and the lower end of the head restraint assembly are positioned between the mounting surface and the lower end.

2. The vehicle seat assembly of claim 1 wherein the first massage element comprises a first bladder, and the second massage element comprises a second bladder.

3. The vehicle seat assembly of claim 2 further comprising at least one valve in fluid communication with the first bladder and the second bladder; and
a controller in communication with the at least one valve to control inflation of the first bladder and inflation of the second bladder.

4. The vehicle seat assembly of claim 3 wherein the controller controls the at least one valve to inflate the first bladder and inflate the second bladder in response to receiving a signal indicative of the seat back being in a reclined position such that the first and second bladders cooperate to define a cradle.

5. The vehicle seat assembly of claim 3 wherein the controller controls the at least one valve to provide a massage effect via the first and second bladders.

6. The vehicle seat assembly of claim 5 wherein the controller controls an inflation duration or an inflation level of each of the first and second bladders to provide the massage effect as a selected one of a plurality of massage effects.

7. The vehicle seat assembly of claim 1 wherein the projection is positioned to overlap at least one vertebra of the occupant in a range of C2 to T5 vertebrae.

8. The vehicle seat assembly of claim 1 wherein the head restraint assembly further comprises a third massage element and a fourth massage element supported by the substrate; and
wherein the first and second massage elements are positioned between the lower end of the head restraint assembly and the third and fourth massage elements.

9. The vehicle seat assembly of claim 8, wherein the first and second massage elements are laterally opposite to one another; and
wherein the third and fourth massage elements are laterally opposite to one another.

10. The vehicle seat assembly of claim 9 wherein the first and second massage elements are spaced apart from one another by a first distance; and
wherein the third and fourth massage elements are spaced apart by a second distance.

11. The vehicle seat assembly of claim 10 wherein the second distance is less than the first distance.

12. The vehicle seat assembly of claim 1 wherein the first massage element is provided by a first massage node, and the second massage element is provided by a second massage node.

13. The vehicle seat assembly of claim 12 further comprising at least one actuator connected to the first massage node and the second massage node; and
a controller in communication with the at least one actuator to control the first massage node and the second massage node to provide a massage effect for the occupant.

14. The vehicle seat assembly of claim 1 wherein the head restraint assembly further comprises a carrier plate connecting at least one of the first and second massage elements to the projection, the carrier plate movable relative to the projection to adjust a location of the at least one of the first and second massage elements relative to the projection.

15. The vehicle seat assembly of claim 1 wherein a midline of the head restraint assembly extends between the first massage element and the second massage element.

16. The vehicle seat assembly of claim 1 wherein the head restraint assembly further comprises:
a trim cover extending over the main body, the projection, and the first and second massage elements of the head restraint assembly; and
a tie down connecting the trim cover to the projection between the first and second massage elements.

17. A vehicle seat assembly comprising:
a substrate defining a head restraint with a continuous support surface for an occupant, the continuous support surface extending downwardly to overlap a head and at least one vertebra of the occupant in a range of C2 to T5 vertebrae; and
a pair of massage elements supported by the continuous support surface such that the pair of massage elements is positioned to contact the occupant in the range.

18. The vehicle seat assembly of claim 17 further comprising a second pair of massage elements supported by the substrate, the second pair of massage elements positioned between an upper edge of the head restraint and the first pair of massage elements.

19. The vehicle seat restraint assembly of claim 17 further comprising a second pair of massage elements supported by the substrate, the first pair of massage elements transversely positioned between the second pair of massage elements.

20. A method of controlling a vehicle seat assembly, the method comprising:
selectively actuating the first and second massage elements of a downwardly extending projection of a head restraint assembly, positioned between a transverse mounting surface and a lower edge of the head restraint assembly; and
concurrently actuating the first and second massage elements in response to a seat back being in a reclined position such that the first and second massage elements cooperate to define a cradle.
